(19) United States
(12) Patent Application Publication
(10) Pub. No.: US 2016/0085539 A1
(43) Pub. Date: Mar. 24, 2016

(54) Updating Method and Electronic System thereof

(71) Applicant: Wistron Corporation, New Taipei City (TW)

(72) Inventor: Jung-Chieh Hsieh, New Taipei City (TW)

(21) Appl. No.: 14/554,051

(22) Filed: Nov. 26, 2014

(30) Foreign Application Priority Data
Sep. 18, 2014 (TW) 103132317

(51) Int. Cl. G06F 9/445; H04L 29/08

(52) U.S. Cl. CPC G06F 8/65; H04L 67/10

(57) ABSTRACT

An updating method for an electronic system with a plurality of hardware devices is disclosed. The updating method includes selecting one of the plurality of hardware devices as a first layer device; selecting at least one of the hardware devices as at least one second layer device; performing, by the first layer device, an updating process according to a software component; transmitting, by the first layer device, a first notification message; and accessing, by the at least one second layer device, the software component from the first layer device according to the first notification message and performing, by the at least one second layer device, the updating process according to the software component.

### BACKGROUND OF THE INVENTION

1. Field of the Invention

The present invention relates to an updating method and electronic system thereof, and more particularly, to an updating method capable of automatically updating a plurality of hardware devices and the electronic system thereof.

2. Description of the Prior Art

With the advancement of technology, electronic systems are increasingly used in daily life. Many electronic systems, particularly embedded systems and devices, employ non-volatile memory to store system software for the electronic system. Conventionally, it is sometimes required the non-volatile memory to be updated with a new software update component. This requirement could arise, for example, if the manufacturer releases a software revision to fix bugs in the old version or to incorporate new features of the electronic system.

Further, the programmable content of the embedded hardware device can be updated via the network or the operating system without specific devices. For example, after the user controls the embedded hardware device to enter an updating mode via the operating system, the user may transmit new programmable content to the embedded hardware device via interfaces such as system bus, low pin count bus, inter-integrated circuit (I²C) and universal serial bus (USB), to perform the updating process. In addition, the user may update the new programmable content to a sever of the embedded hardware device via the network and instruct the embedded hardware device to download the new programmable content from the specific sever or the specific internet protocol address. According to the above methods, the user needs to perform the updating process for each of the embedded hardware devices. When the number of the embedded hardware device increases, the time of updating all of the embedded hardware devices significantly raises. As can be seen from the above, the prior art needs to be improved.

### SUMMARY OF THE INVENTION

In order to solve the above problem, the present invention provides an updating method capable of automatically updating a plurality of hardware device and electronic system thereof.

An embodiment of the present invention discloses an updating method for an electronic system with a plurality of hardware devices, the updating method comprising selecting one of the plurality of hardware devices as a first layer device; selecting at least one of the hardware devices as at least one second layer device; performing, by the first layer device, an updating process according to a software component; transmitting, by the first layer device, a first notification message when the first layer device finishes the updating process; and accessing, by the at least one second layer device, the software component from the first layer device according to the first notification message and performing, by the at least one second layer device, the updating process according to the software component.

Another embodiment of the present invention further discloses an electronic system comprising a plurality of hardware devices, wherein the plurality of hardware devices comprising a first layer device, for performing an updating process according to a software component and transmitting a first notification message when finishing the updating process; and at least one second layer device, for accessing the software component from the first layer device according to the first notification message when receiving the first notification message and performing the updating process according to the software component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic system according to an example of the present invention.

FIGS. 2A and 2B are schematic diagrams of operation procedures of the electronic system shown in FIG. 1 according to an example of the present invention.

FIG. 3 is a flowchart of an updating method according to an example of the present invention.

### DETAILED DESCRIPTION

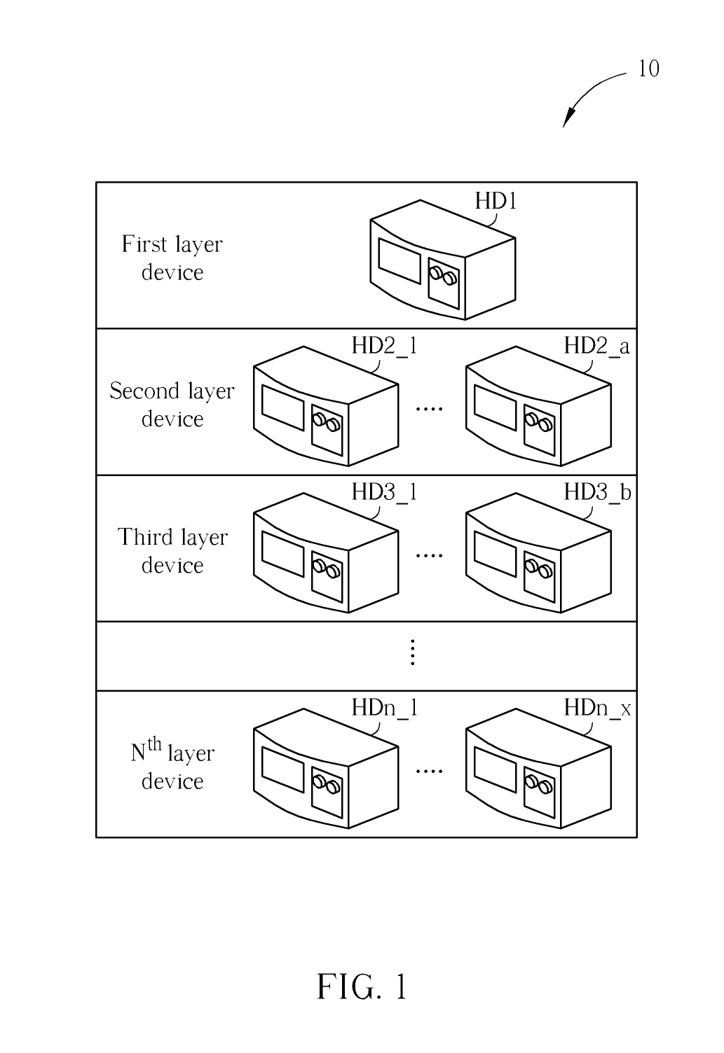

Please refer to FIG. 1, which is a schematic diagram of an electronic system 10 according to an example of the present invention. The electronic system 10 may be a server system and comprise a first layer device HD1, second layer devices HD2_1-HD2_a, third layer devices HD3_1-HD₁₃ b, . . . , and n^{th} layer devices HDn_1-HDn_x, wherein the first layer device HD1, the second layer devices HD2_1-HD2_a, the third layer devices HD3_1-HD3_b, . . . , and the n^{th} layer devices HDn_1-HDn_x may be a plurality of servers connected to network in the server system. When an operation software of a hardware component HC (e.g. programmable content of an embedded device on a motherboard) in each of the first layer device HD1, the second layer devices HD2_1-HD2_a, the third layer devices HD3_1-HD3_b, . . . , and the n^{th} layer devices HDn_1-HDn_x is required to be updated, the user only needs to manually control the first layer device HD1 to perform an updating process according to a software component SC, to update the operation software of the hardware component HC in the first layer device HD1. After the updating process finished, the first layer device HD1 automatically controls the second layer devices HD2_1-HD2_a to perform the updating process according to the software component SC. Further, the second layer devices HD2_1-HD2_a also automatically control the third layer devices HD3_1-HD3_b to perform the updating process according to the software component SC after the second layer devices HD2_1-HD2_a finished the updating process, and so on. As a result, the time of the user updates the operation software of the hardware component HC in each of the first layer device HD1, the second layer devices HD2_1-HD2_a, the third layer devices HD3_1-HD3_b, . . . , and the n^{th} layer devices HDn_1-HDn_x is significantly reduced.

In detail, according to updating sequence, the user may select one of the plurality hardware devices of the electronic system 10 as the first layer device HD1, select at least one of the plurality of the hardware devices as the second layer devices HD2_1-HD2_a located at the next layer of the first layer device HD1, and so on. In an example, the first layer device HD1 is randomly selected by the user. In addition, the second layer devices HD2_1-HD2_a, the third layer devices HD3_1-HD3_b, . . . , and the n^{th} layer devices HDn_1-HDn_x may be selected according to internet protocol (IP) addresses of the hardware devices. In FIG. 1, the first layer device HD1, the second layer devices HD2_1-HD2_a, the third layer devices HD3_1-HD3_b, . . . , and the n^{th} layer devices HDn_1-HDn_x are in the same network domain. The user selects the hardware devices with the IP addresses from xx.xx.xx.0 to xx.xx.xx.30 as the second layer devices HD2_1-HD2_a and selects the hardware devices with the IP addresses from xx.xx.xx.31 to xx.xx.xx.100 as the third layer devices HD3_1-HD3_b. The method of defining the second layer devices HD2_1-HD2_a, the third layer devices HD3_1-HD3_b, . . . , and the n^{th} layer devices HDn_1-HDn_x can be altered according to different applications and design concepts, and are not limited herein.

When the operation software of the hardware components HC in the first layer HD1, the second layer devices HD2_1-HD2_a, the third layer devices HD3_1-HD3_b, . . . , and the n^{th} layer devices HDn_1-HDn_x are required to be updated, the user controls the first layer device HD1 to access the software component SC and to perform the updating process according to the software component SC, to update the operation software of the hardware component HC. When the first layer device HD1 finishes the updating process, the first layer device HD1 automatically transmits (e.g. broadcasts) a notification message NM1 via the network, wherein the notification message NM1 comprises a current level CL, an accessing path AP and an accessing file name AN. Since the first layer device HD1 is the first hardware device being updated, the current level CL of the notification message NM1 transmitted by the first layer deice HD1 is set to the highest level (e.g. 1). The accessing path AP is the IP address of the first layer device HD1 and the accessing file name AN is the file name of the software component SC stored in the first layer device HD1. When the second layer devices HD2_1-HD2_a, which are located at the next layer of the first layer device HD1, receives the notification message NM1, the second layer devices HD2_1-HD2_a determine that the first layer device HD1 has finished the updating process according to the current level CL. Next, the second layer devices HD2_1-HD2_a access the software component SC from the first layer device HD1 according to the accessing path AP and the accessing file name AN in the notification message NM1 and perform the updating process. Note that, when the third layer device HD3_1-HD3_b, . . . , and the n^{th} layer devices HDn_1-HDn_x receive the notification message NM1, the third layer device HD3_1-HD3_b, . . . , and the n^{th} layer devices HDn_1-HDn_x determine not to perform any operation according to the current level CL of the notification message NM1. That is, after the first layer device HD1 finished the updating process, the first layer device HD1 becomes a server and the second layer devices HD2_1-HD2_a become clients to access the software component SC from the server.

Similarly, the second layer device HD2_1 also transmits a notification NM2_1 when finishing the updating process, wherein the notification message NM2_1 comprises the current level CL, the accessing path AP and the accessing file name AN. Different from the notification message NM1, the current level CL of the notification message NM2_1 is set to the level of the second layer device HD2_1 (e.g. 2), the accessing path AP of the notification message NM2_1 is the IP address of the second layer device HD2_1, and the accessing file name AN of the second notification message NM2_1 is the name of the software component SC stored in the second layer device HD2_1. When the third layer devices HD3_1-HD3_b receive the notification message NM2_1, the third layer devices HD3_1-HD3_b determine that one of the second layer device HD2_1-HD2_a finished the updating process according to the current level CL of the notification message NM2_1 and access the software component SC from the second layer device HD2_1, which finished the updating process, according to the accessing path AP and the accessing file name AN of the notification message NM2_1, to perform the updating process. The operation procedures of the second layer devices HD2_2-HD2_a can be referred to those of the second layer device HD2_1, and are not described herein for brevity. According to the above example, via classifying the plurality of hardware devices in the electronic system 10 into the first layer device HD1, the second layer devices HD2_1-HD2_n, the third layer devices HD3_1-HD3_b, . . . , and the n^{th} layer devices HDn_1-HDn_x, the user is only required to control the first layer device HD1 to perform the updating process and the second layer devices HD2_1-HD2_n, the third layer devices HD3_1-HD3_b, . . . , and the n^{th} layer devices HDn_1-HDn_x will sequentially perform the updating process according to the layer sequence. As a result, the time of the user update the operation software of the hardware components HC in the first layer device HD1, the second layer devices HD2_1-HD2_n, the third layer devices HD3_1-HD3_b, . . . , and the n^{th} layer devices HDn_1-HDn_x is significantly reduced.

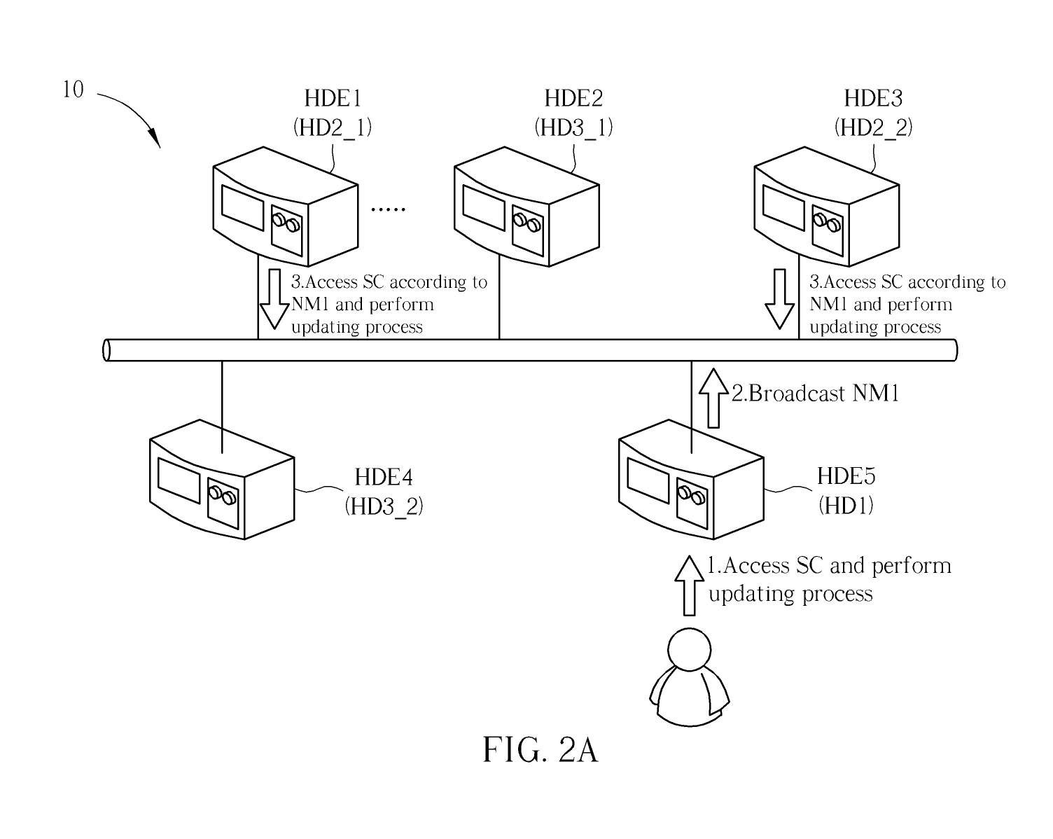

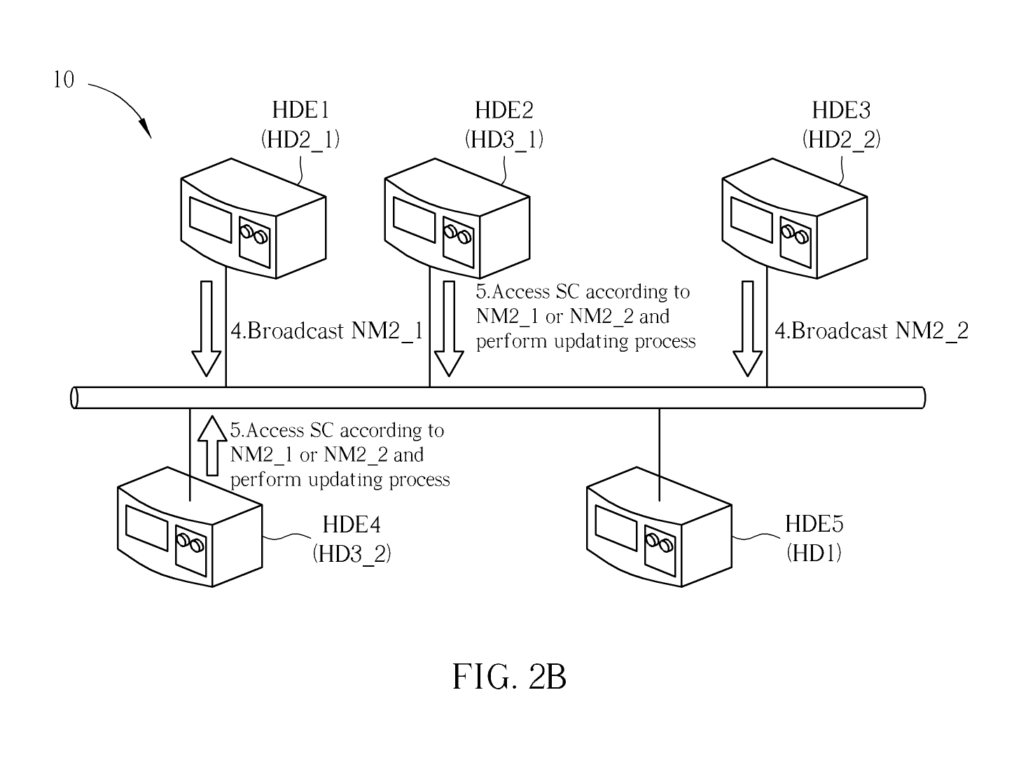

As to the detailed operations of the electronic system 10 performs the updating process please refer to the following. Please refer to FIGS. 2A and 2B, which are schematic diagrams of the operation procedures of the electronic system 10 according to an example of the present invention. In order to simplify illustrations, FIGS. 2A and 2B only show hardware devices HDE1-HDE5. In this example, the user selects the hardware device HDE5 as the first layer device HD1, selects the hardware devices HDE1 and HDE3 as the second layer devices HD2_1 and HD2_2, and selects the hardware devices HDE2 and HDE4 as the third layer devices HD3_1 and HD3_2. As shown in FIG. 2A, the user first controls the hardware device HDE5 (i.e. the first layer device HD1) to access the software component SC and to perform the updating process. When the hardware device HDE5 finishes the updating process, the hardware device HDE5 broadcasts the notification message NM1 via the network. In the notification message NM1, the current level CL is set to 1, the accessing path AP is the IP address of the hardware device HDE5 and the accessing file name AN is the file name of the software component SC stored in the hardware device HDE5.

Via the network, all of the hardware devices HDE1-HDE4 receive the notification message NM1. Since the current level CL of the notification message NM1 is set to 1, the hardware devices HDE2 and HDE4 (i.e. the third layer devices HD3_1 and HD3_2) do not perform any operation according to the notification message NM1. On the other hand, the hardware devices HDE1 and HDE3 (i.e. the second layer devices HD2_1 and HD2_2) determine to begin performing the updating process according to the current level CL of the notification message NM1. According to the accessing path AP and the accessing file name AN, the hardware devices HDE1 and HDE3 access the software component SC from the hardware device HDE5 and perform the updating process.

Please refer to FIG. 2B, when the hardware devices HDE1 and HDE3 finish the updating process, the hardware devices HDE1 and HDE3 respectively broadcast the notification messages NM2_1 and NM2_2. Both the current levels CL of the notification messages NM2_1 and NM2_2 are 2. The accessing paths AP of the notification messages NM2_1 and NM2_2 are the IP addresses of the hardware devices HDE1 and HDE3, respectively, and the accessing file names AN of the notification messages NM2_1 and NM2_2 are the file name of the software components SC stored in the hardware devices HDE1 and HDE3, respectively. In such a condition, the hardware device HDE5 does not perform any operation since the current level CL of the notification messages NM2_1 and NM2_2 are 2. When the hardware devices HDE2 and HDE4 receive one of the notification messages NM2_1 and NM2_2, the hardware devices HDE2 and HDE4 determine to perform the updating process according to the current level CL of the received one of the notification messages NM2_1 and NM2_2. According to the accessing paths AP and accessing file names AN of the notification messages NM2_1 and NM2_2, the hardware devices HDE2 and HDE4 access the software component SC from the hardware device HDE1 or HDE3. For example, the hardware devices HDE2 and HDE4 may determine to access the software component SC from the hardware device HDE1 or HDE3 according to the network state and/or the operation states of the hardware devices HDE1 and HDE3. In an example, the hardware device HDE2 accesses the software component SC from the hardware device HDE1 according to the notification message NM2_1. When the hardware device HDE4 starts to access the software component SC from the hardware device HDE1 according to the notification message NM2_1, the hardware device HDE4 acknowledges that the operation state of the hardware device HDE1 is busy and changes to access the software component SC from the hardware device HDE3 according to the notification message NM2_2.

The above examples classify the hardware devices into different layers, for allowing the hardware devices to automatically perform the updating process according to the layer sequence. The time of the user spent on performing the updating process therefore can be reduced. According to different applications and design concepts, those with ordinary skill in the art may observe appropriate alternations and modifications. For example, when finishing the updating process, the first layer device HD1 may transmit the notification message NM1 to the second layer devices HD2_1-HD2_a via a multi-cast method, to avoid decreasing the network performance. In addition, when utilizing the broadcast method to transmit the notification message (e.g. the notification message NM1), the hardware devices are required to be at the same network domain. In comparison, the hardware devices may be at different network domains when utilizing the multi-cast method to transmit the notification messages. The design of the electronic system can be more flexible, therefore.

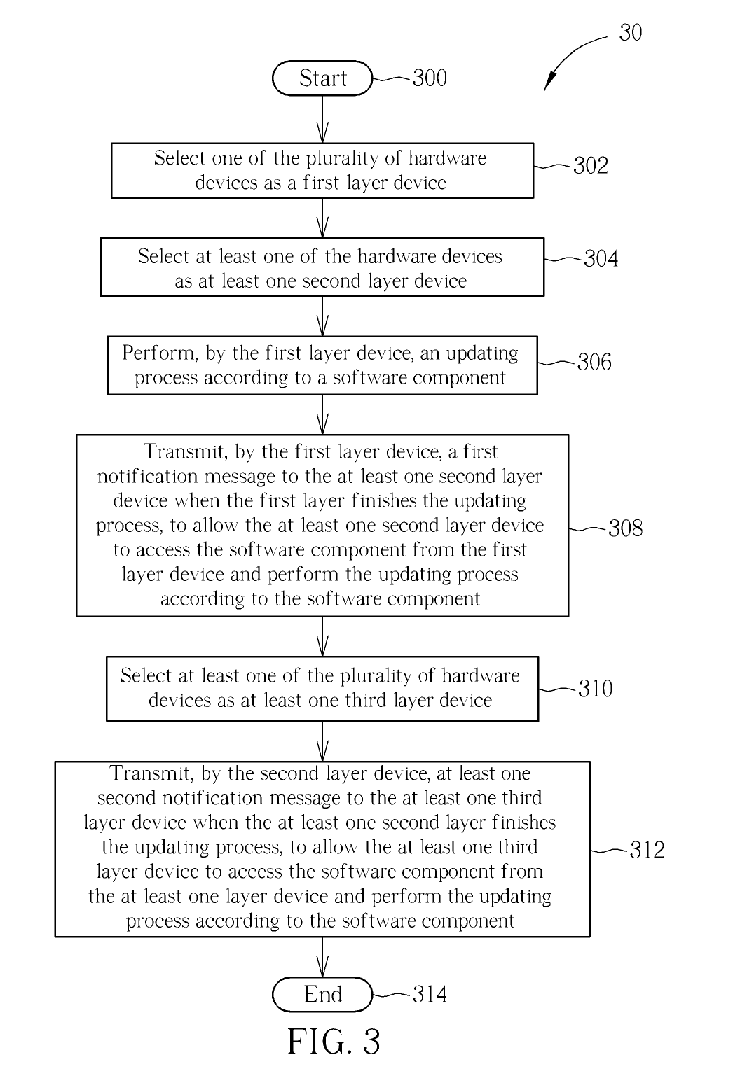

The procedures of the electronic system 10 performs the updating process can be summarized into an updating method 30, as shown in FIG. 3. The updating method 30 can be utilized in an electronic system (e.g. a server system) with a plurality of hardware devices and comprises the following steps:

Step 300: Start.

Step 302: Select one of the plurality of hardware devices as a first layer device.

Step 304: Select at least one of the hardware devices as at least one second layer device.

Step 306: Perform, by the first layer device, an updating process according to a software component.

Step 308: Transmit, by the first layer device, a first notification message to the at least one second layer device when the first layer finishes the updating process, to allow the at least one second layer device to access the software component from the first layer device and perform the updating process according to the software component.

Step 310: Select at least one of the plurality of hardware devices as at least one third layer device.

Step 312: Transmit, by the second layer device, at least one second notification message to the at least one third layer device when the at least one second layer finishes the updating process, to allow the at least one third layer device to access the software component from the at least one layer device and perform the updating process according to the software component.

Step 314: End.

According to the updating method 30, the plurality of hardware devices in the electronic system is classified into a first layer device, second layer devices, and third layer devices with different layers. When the user completes the updating process of the first layer device, the first layer device transmits a notification message to the second layer devices, to allow the second layer device to perform the updating process, and so on. Therefore, the time of updating the plurality of hardware devices in the electronic system can be reduced. Note that, the number of layers of the plurality hardware devices may be adjusted according to the number of the hardware devices in the electronic system, and is not limited to 3 layers described in the updating method 30. The detailed operations of the updating method 30 can be referred to the above, and are not narrated herein for brevity.

To sum up, the above examples classify the plurality of hardware devices in the electronic system into different layers. When a single hardware device finishes the updating process, the hardware device automatically inform the hardware devices of the next layer to perform the updating process. As a result, the time spending on updating the plurality of hardware devices is reduced, the manpower, and the cost of maintaining the electronic system are decreased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An updating method for an electronic system with a plurality of hardware devices, the updating method comprising:
selecting one of the plurality of hardware devices as a first layer device;
selecting at least one of the hardware devices as at least one second layer device;
performing, by the first layer device, an updating process according to a software component;
transmitting, by the first layer device, a first notification message when the first layer device finishes the updating process; and
accessing, by the at least one second layer device, the software component from the first layer device according to the first notification message and performing, by the at least one second layer device, the updating process according to the software component.

2. The updating method of claim 1, wherein the plurality of hardware devices is in the same network domain.

3. The updating method of claim 1, wherein the step of selecting the at least one of the hardware devices as the at least one second layer device comprises:
selecting the at least one of the hardware devices, according to a plurality of internet protocol addresses of the plurality hardware devices, as the at least one second layer device.

4. The updating method of claim 1, wherein the first layer device transmits the first notification message via a broadcast method.

5. The updating method of claim 1, wherein the first layer device transmits the first notification message to the at least one second layer device via a multicast method.

6. The updating method of claim 1, wherein the first notification message comprises an updating path, an updating file name and a current level.

7. The updating method of claim 1, further comprising:
selecting at least one of the plurality of hardware devices as at least one third layer device;
transmitting, by the at least one second layer device, at least one second notification message when the at least one second layer device finishes the updating process; and
accessing, by the at least one third layer device, the software component from the at least one second layer device according to the at least one second notification message and performing, by the at least one third layer device, the updating process according to the software component.

8. An electronic system comprising a plurality of hardware devices, wherein the plurality of hardware devices comprising:
a first layer device, for performing an updating process according to a software component and transmitting a first notification message when finishing the updating process; and
at least one second layer device, for accessing the software component from the first layer device according to the first notification message when receiving the first notification message and performing the updating process according to the software component.

9. The electronic system of claim 8, wherein the plurality of hardware devices is in the same network domain.

10. The electronic system of claim 8, wherein the at least one second layer device is selected from the plurality of hardware devices according to a plurality of internet protocol addresses of the plurality hardware devices.

11. The electronic system of claim 8, wherein the first layer device transmits the first notification message via a broadcast method.

12. The electronic system of claim 8, wherein the first layer device transmits the first notification message to the at least one second layer device via a multicast method.

13. The electronic system of claim 8, wherein the first notification message comprises an updating path, an updating file name and a current level.

14. The electronic system of claim 8, wherein the plurality of hardware devices further comprising:
at least one third layer device, for accessing the software component from the at least one second layer device according to at least one second notification message when receiving the at least one second notification message and performing the updating process according to the software component;
wherein the second notification message is transmitted by the at least one second layer device when the at least one second layer device finishes the updating process.
